(19) United States
(12) Patent Application Publication
(10) Pub. No.: US 2011/0242362 A1
(43) Pub. Date: Oct. 6, 2011

(54) TERMINAL DEVICE

(75) Inventors: Masashi TAKEMURA, Osaka (JP); Hirofumi NAKAGAKI, Osaka (JP)

(73) Assignee: PANASONIC CORPORATION, OSAKA (JP)

(21) Appl. No.: 12/951,188

(22) Filed: Nov. 22, 2010

(30) Foreign Application Priority Data
Nov. 25, 2009 (JP) 2009-267112

(51) Int. Cl. G06K 9/60; H04N 5/76

(52) U.S. Cl. 348/231.99; 382/305; 348/E05.031

(57) ABSTRACT

In the case where a plurality of types of attribute information and a plurality of types of menu screen information of different formats are recorded on a nonvolatile recording medium by a plurality of types of terminal devices, the display device cannot determine which information is to be processed. This makes it difficult for the user to view images or the like. A terminal device 1001 according to the present invention generates user data 2004 such as image information, living body information or the like and attribute information 2005 representing attribute of the generated user data 2004. The terminal device 1001 records, on the nonvolatile recording medium 1002, control information 2006 corresponding to the attribute information 2005 and representing a procedure of displaying the user data 2004 by a display device 1003.

### BACKGROUND OF THE INVENTION

1. Field of the Invention

The present invention relates to a terminal device, and specifically to processing performed by an imaging device, a health measurement device or the like to record information on a nonvolatile recording medium.

2. Description of the Related Art

First, digital still cameras will be described. In a digital still camera, an image formed on an imaging element formed of a CCD or a CMOS device is read as digital data, classified into folders in accordance with a format such as a DCF system (Design rule for Camera File system) or the like and provided with a file name with a serial number, and recorded on a nonvolatile recording medium such as an SD memory card or the like. When wishing to view images already taken, a user can view the images on a display included in a main body of the digital still camera; or can detach the SD memory card from the digital still camera, connect the SD memory card to a personal computer or a TV having an SD memory card slot, read image data from the SD memory card and view the images. For viewing the images, the images are sequentially displayed in the order of the shooting or in the order of the serial number supplied to the file name, or displayed in a list.

Recently, the capacity of recording mediums such as SD memory cards and the like has been increased, and the number of images which can be recorded thereon has become huge. Therefore, it has become difficult for the user to find images that he/she wishes to see and view such images with a conventional method of viewing the images in the order of the shooting or the like.

Hence, in order to allow the user to view the images, there is software for digital still cameras or personal computers which reads date information described in image files in a format defined by a file system or an EXIF (Exchangeable Image File Format) and presents the images to the user in the form of a list as being classified on a calendar.

Japanese Laid-Open Patent Publication No. 2005-33832 discloses an image management device for classifying image information and attribute information of the image information, generating a menu screen which presents selectable alternatives to the user, and recording the image information, the attribute information and the menu screen on a recording medium. This allows the user to see the image data with a simple operation.

### SUMMARY OF THE INVENTION

As described above, as the capacity of the recording mediums such as SD memory cards and the like is increased, the number of images which can be recorded thereon has become huge. It has become difficult to find and view desired images with a method of viewing the images in the order of the shooting or in the order of the serial number provided to the file name.

In the case where information such as the shooting time or the like is obtained from the information recorded on an image file in a format defined by a file system or an EXIF and displayed as being classified when the user wishes to view the images, it is easy to find a desired image. However, this requires processing of reading necessary information such as the date or the like from all the image files and classifying the information. Therefore, it needs a long time to display the classified results.

Using the method described in Japanese Laid-Open Patent Publication No. 2005-33832, images are classified using attribute information, a menu screen is generated, and the image information, the attribute information, and the menu screen are recorded on a recording medium beforehand. Therefore, the user can see the image data with a simple operation. However, when another image management device records new image information, attribute information and menu screen on a recording medium already having the image information, attribute information and menu screen recorded thereon, a plurality of menu screens which are not related to each other are on one recording medium. In such a situation, which menu screen to be displayed cannot be determined. When one menu screen is optionally selected and displayed, the menu recorded by the image management device different from the image management device that recorded the selected menu screen is not displayed. The image information recorded by the different image management device cannot be viewed.

In the case where a plurality of types of attribute information and menu screens of different formats are recorded on one nonvolatile recording medium, the correspondence between the attribute information and the menu screens is not found, and so appropriate processing cannot be performed to allow the user to view the images.

In order to record image information, attribute information and a menu screen by another image management device on a recording medium already having image information, attribute information and a menu screen recorded thereon and allow all the image information to be viewed from one menu screen, it is required to read the attribute information recorded on the recording medium, classify information using the recorded attribute information together with the attribute information to be written, create a menu screen, and record the created menu screen on the recording medium. However, the description format of the attribute information may be different by image management device, and it is difficult to classify information using the attribute information described in different formats and create a menu screen.

The present invention, made in light of the above points, provides a terminal device for improving the ease of use for a user to view data.

A terminal device according to the present invention includes a user data generation section for generating user data; an attribute information generation section for generating attribute information which represents attribute of the generated user data; and control information processing section for recording, on a nonvolatile recording medium, control information which corresponds to the attribute information and represents a procedure of displaying the user data on a display device. The control information includes individual control information representing a procedure of displaying the user data; and comprehensive control information including link information to the individual control information.

According to an embodiment, in the case where different user data generated by a device different from the terminal device and different individual control information representing a procedure of displaying the different user data are already recorded on the nonvolatile recording medium, the comprehensive control information further includes link information to the different individual control information.

According to an embodiment, the comprehensive control information provides the display device with a user interface which allows a user to select which of the user data generated by the terminal device and the different user data generated by the different device is to be displayed.

According to an embodiment, the comprehensive control information includes device specifying information for specifying each of the terminal device and the different device.

According to an embodiment, the device specifying information is a test string capable of specifying a model of each of the terminal device and the different device.

According to an embodiment, the device specifying information is image information capable of specifying a model of each of the terminal device and the different device.

According to an embodiment, the control information processing section checks whether or not control information is already recorded on the nonvolatile recording medium, and determines a type of control information to be recorded on the nonvolatile recording medium in accordance with a result of the checking.

According to an embodiment, in the case where as a result of the checking, neither individual control information nor comprehensive control information is recorded on the nonvolatile recording medium, the control information processing section generates the comprehensive control information including the link information to the individual control information generated by the terminal device, and records the generated individual control information and the generated comprehensive control information on the nonvolatile recording medium.

According to an embodiment, in the case where as a result of the checking, individual control information is already recorded on the nonvolatile recording medium but comprehensive control information is not recorded, and identification information of the individual control information generated by the terminal device does not match identification information of the already recorded individual control information, the control information processing section generates comprehensive control information including the link information to the generated individual control information and link information to the already recorded individual control information, and records the generated individual control information and the generated comprehensive control information on the nonvolatile recording medium.

According to an embodiment, in the case where as a result of the checking, comprehensive control information and individual control information are already recorded on the nonvolatile recording medium, and identification information of the individual control information generated by the terminal device matches identification information of the already recorded individual control information, the control information processing section does not record the generated individual control information on the nonvolatile recording medium.

According to an embodiment, in the case where as a result of the checking, comprehensive control information and individual control information are already recorded on the nonvolatile recording medium, and identification information of the individual control information generated by the terminal device does not match identification information of the already recorded individual control information, the control information processing section reads the comprehensive control information already recorded on the nonvolatile recording medium, generates new comprehensive control information including the link information to the generated individual control information and link information included in the already recorded comprehensive control information, records the generated individual control information on the nonvolatile recording medium and also rewrites the comprehensive control information already recorded on the nonvolatile recording medium with the new comprehensive control information.

According to an embodiment, the control information processing section causes the control information to correspond to the attribute information by recording the control information and the attribute information in the same directory in the nonvolatile recording medium.

According to an embodiment, the control information processing section causes the control information to correspond to the attribute information by causing a file path representing the position of the attribute information in the nonvolatile recording medium to be included in the control information.

According to an embodiment, the terminal device is an imaging device; and the user data is image shooting data.

According to an embodiment, the terminal device is a health measurement device; and the user data is living body information.

A nonvolatile recording medium according to the present invention includes user data; attribute information representing attribute of the generated user data; and control information corresponding to the attribute information and representing a procedure of displaying the user data by a display device.

According to an embodiment, the control information includes individual control information representing a procedure of displaying the user data; and comprehensive control information including link information to the individual control information.

According to an embodiment, the user data and the control information are information generated and recorded on the nonvolatile recording medium by a terminal device; different user data generated by device different from the terminal device and different individual control information representing a procedure of displaying the different user data are recorded on the nonvolatile recording medium; and the comprehensive control information further includes link information to the different individual control information.

According to an embodiment, the comprehensive control information provides the display device with a user interface which allows a user to select which of the user data generated by the terminal device and the different user data generated by the different device is to be displayed.

According to an embodiment, the control information includes a file path representing the position of the attribute information in the nonvolatile recording medium in order to show the correspondence between the control information and the attribute information.

According to an embodiment, the comprehensive control information includes device specifying information for specifying each of the terminal device and the different device.

According to an embodiment, the terminal device is an imaging device; and the user data is image shooting data.

According to an embodiment, the terminal device is a health measurement device; and the user data is living body information.

According to the present invention, the terminal device records attribute information and control information corresponding thereto on a nonvolatile recording medium. Even in the case where different terminal devices record attribute information of different formats on the same nonvolatile recording medium, the correspondence between such a plurality of types of attribute information can be specified by recording control information corresponding to each of the plurality of types of attribute information. Therefore, by processing the control information by the display device, user data is allowed to be viewed using the attribute information.

The terminal device also generates, as control information, individual control information representing the procedure of displaying the user data and comprehensive control information including the link information to the individual control information. In the case where user data and individual control information generated by a device different from the terminal device are already recorded on the nonvolatile recording medium, the terminal device generates comprehensive control information including both of the link information to the individual control information generated by the terminal device and the link information to the individual control information generated by the different device, and records the comprehensive control information on the nonvolatile recording medium. In the case where various types of user data generated by a plurality of types of terminal devices are present on the nonvolatile recording medium in a mixed state, the display device cannot determine which information to be displayed as described above. However, by generating and recording the comprehensive control information on the nonvolatile recording medium on the side of the terminal device as according to the present invention, even where various types of user data are present in a mixed state, the display device can display appropriate information in accordance with the comprehensive control information.

### BRIEF DESCRIPTION OF THE DRAWINGS

FIG. 1 is a block diagram showing a system structure in an embodiment of the present invention.

FIG. 2 is a block diagram showing an imaging device and a nonvolatile recording medium in an embodiment of the present invention.

FIG. 3 is a block diagram showing an imaging section in an embodiment of the present invention.

FIGS. 4(a) and (b) show an attribute information management table in an embodiment of the present invention.

FIG. 5 is a block diagram showing a control information processing section in an embodiment of the present invention.

FIG. 6 is a flowchart showing an operation of the control information processing section in an embodiment of the present invention.

FIGS. 7(a) and (b) show a display screen in an embodiment of the present invention.

FIGS. 8(a) through (c) are flowcharts showing an operation of the control information processing section in an embodiment of the present invention.

FIG. 9 is a block diagram showing a display device in an embodiment of the present invention.

FIG. 10 is a flowchart showing an operation of the display device in an embodiment of the present invention.

FIGS. 11(a) and (b) show a display screen in an embodiment of the present invention.

FIG. 12 shows information held by the nonvolatile recording medium in an embodiment of the present invention.

### DETAILED DESCRIPTION OF PREFERRED EMBODIMENTS

Hereinafter, embodiments of the present invention will be described with reference to the drawings.

A terminal device according to the present invention is, for example, an imaging device for taking a picture of a subject and creating image information, a health measurement device for making measurements on a living body and obtaining living body information, or the like. The imaging device is, for example, a digital still camera, a digital video camera or the like. The health measurement device is, for example, a weighing device, a tonometer, a pedometer, an activity meter, or the like.

Hereinafter, an embodiment in which the terminal device is an imaging device will be described. The imaging device records obtained image information (still picture data, moving picture data, etc.) as user data on a nonvolatile recording medium, and a display device displays the image read from the nonvolatile recording medium in accordance with control information.

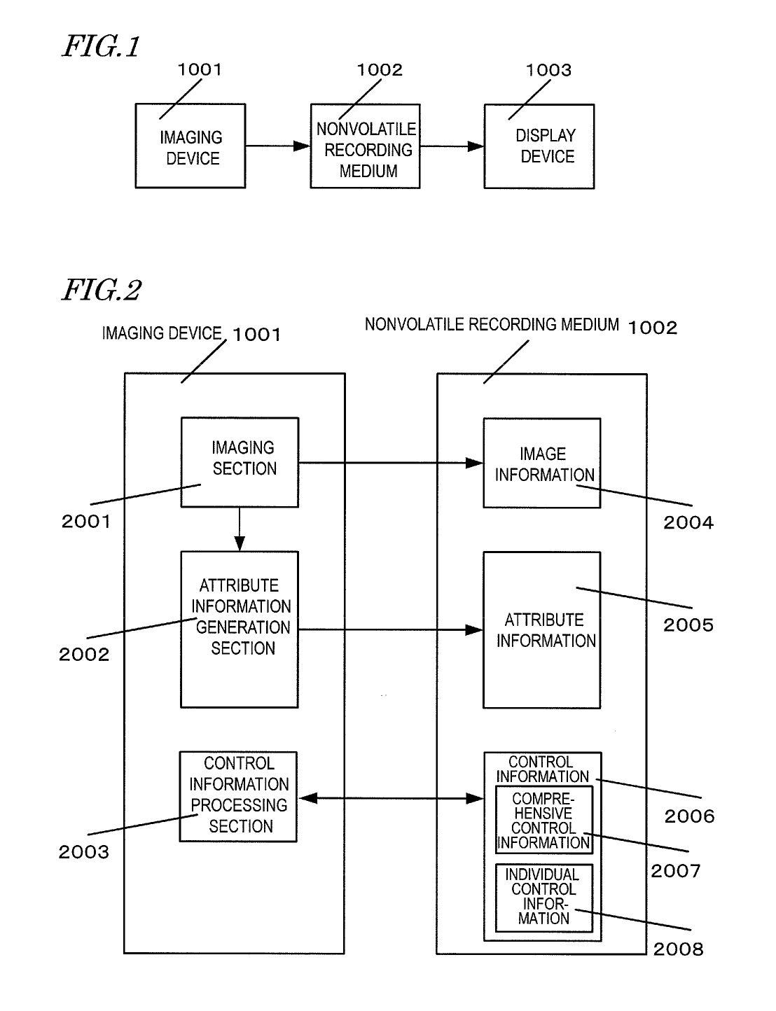

FIG. 1 shows an imaging device 1001 as a terminal device in this embodiment, a nonvolatile recording medium 1002 on which information may be recorded by the imaging device 1001, and a display device 1003 for interpreting the information recorded on the nonvolatile recording medium 1002 and displaying the information on a screen. In the figure, the arrows schematically show the flow of information.

First, the nonvolatile recording medium 1002 is mounted on the imaging device 1001 to put the imaging device 1001 into a state of capable of reading/writing information from/to the nonvolatile recording medium 1002. By performing image shooting in this state, various types of information such as an image or the like are recorded on the nonvolatile recording medium 1002 by the imaging device 1001. Next, the nonvolatile recording medium 1002 is detached from the imaging device 1001 and attached to the display device 1003. The display device 1003 reads various types of information such as an image or the like from the nonvolatile recording medium 1002 and displays the information.

The imaging device 1001 has a function of recording a moving picture or a still picture of a digital still camera, a digital video camera or the like as digital data.

The nonvolatile recording medium 1002 is commonly usable by a plurality of types of terminal devices. The nonvolatile recording medium 1002 is, for example, a semiconductor memory such as an SD memory card, a USB memory or the like; a magnetic drive such as a hard disc drive or the like; an optical disc such as a CD, a DVD or the like; etc. The nonvolatile recording medium 1002 is commonly used by different terminal devices such as, for example, a digital still camera A, a digital video camera B, a weighing device C, a pedometer D and the like. In this case, user data such as image information, living body information and the like generated by the respective terminal devices is recorded on the nonvolatile recording medium 1002 in a mixed state. Especially, a semiconductor memory such as an SD memory card, a USB memory or the like is repeatedly attached to, and detached from, a plurality of types of terminal devices and have information recorded thereon repeatedly, and thus has a high possibility of having various types of user data recorded thereon in a mixed state.

The display device 1003 is assumed to be a TV, a personal computer, a mobile phone, a portable information terminal or the like, and includes a reading device for reading information from the nonvolatile recording medium 1002 and also includes a display section for processing the information read from the nonvolatile recording medium 1002 and displaying the results.

(Structure of the Imaging Device 1001)

As shown in FIG. 2, the imaging device 1001 includes an imaging section 2001 for recording digital data obtained by image shooting and information such as the date or venue of the shooting on the nonvolatile recording medium 1002 as image information (user data) 2004. The imaging device 1001 also includes an attribute information generation section 2002 for generating attribute information 2005 based on the image shooting information from the imaging section 2001 and recording the attribute information 2005 on the nonvolatile recording medium 1002. The imaging device 1001 further includes a control information processing section 2003 for recording control information 2006, used for generating a screen by the display device 1003 using the attribute information 2005, on the nonvolatile recording medium 1002.

The control information 2006 includes 0 or 1 piece of comprehensive control information 2007 and one or more pieces of individual control information 2008. The individual control information 2008 is recorded on the nonvolatile recording medium in correspondence with the type of attribute information. Accordingly, in the case where, for example, two types of attribute information are held on the nonvolatile recording medium, at least two pieces of individual control information are necessary. It is also possible to cause one or more pieces of individual control information to correspond to one piece of attribute information. The types of attribute information will be described later.

Neither the comprehensive control information 2007 nor the individual control information 2008 is limited to being formed of one file, and may be formed of a plurality of files. The individual control information 2008 is information for controlling, for example, a procedure of processing, or a method of displaying, the attribute information 2005 and/or the image information 2004 by the display device 1003.

(Imaging Section 2001)

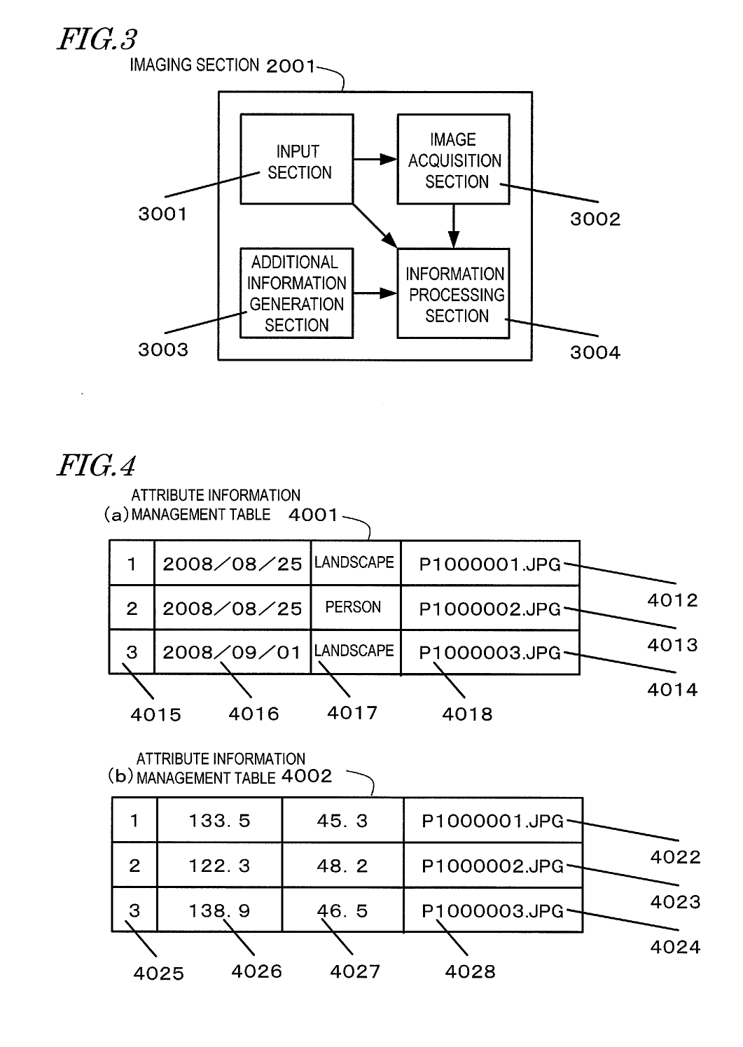

FIG. 3 shows a structure of the imaging section 2001. The imaging section 2001 includes an input section 3001, an image acquisition section 3002, an additional information generation section 3003, and an information processing section 3004.

The input section 3001 is a shutter button, a touch panel, a direction key or the like, and receives an input from a user. By using the input section 3001, the user can perform image shooting, view shot images, and perform settings for image shooting. The settings for image shooting are settings on the shutter speed, aperture, exposure or scene. The settings on the scene are settings on a function of allowing the user to select “landscape”, “person”, “night view”, “macro” or the like from a menu prepared in advance. By selecting one of these scenes, the optimum shutter speed, aperture, image processing method after the shooting, or the like can be selected automatically. The scene information set here is notified to the information processing section 3004. For example, when the user selects “landscape” as the scene by an input, the scene information “landscape” is notified to the information processing section 3004. The above mentioned scenes are merely examples, and various other scenes are conceivable, for example, “sports”, “fireworks”, etc. The scene settings may be automatically performed using the information from the image acquisition section 3002.

The image acquisition section 3002 includes an image sensor such as a CCD, a CMOS sensor or the like; and converts an electric signal obtained by the image sensor into digital data in response to pressing on a shutter button of the input section 3001, compresses the digital data by a format such as JPEG or the like, and notifies the compressed image data to the information processing section 3004. The format of the image data is not limited to JPEG, and may be JIG (Graphics Interchange Format), PNG (Portable Network Graphics) or the like. It is not even necessary that the data be compressed.

The additional information generation section 3003 has a GPS sensor and a clock function; and acquires the latitude and longitude from the GPS sensor in response to pressing on the shutter button of the input section 3001 and notifies this information to the information processing section 3004 as additional information. The additional information generation section 3003 also acquires date/time information from the clock function and also notifies this information to the information processing section 3004 as additional information. The information generated and notified to the information processing section 3004 by the additional information generation section 3003 is not limited to the positional information acquired using the GPS sensor or the date/time information acquired using the clock function, and may be any of various types of information including information on the shutter speed, aperture, exposure, focal length or the like at the time of image shooting which can be acquired from the image acquisition section 3002, or the temperature, humidity, pressure, height above the sea, azimuth, acceleration or the like which can be acquired by any of various types of sensors mounted.

The information processing section 3004 generates the image information 2004 in the EXIF based on the scene information notified from the input section 3001, the image data notified from the image acquisition section 3002, and the additional information notified from the additional information generation section 3003, and records the image information 2004 on the nonvolatile recording medium 1002. The format such as a folder structure or the like for recording is a generally known format such as a DCF or the like. The format of the image information 2004 is not limited to the EXIF, and the format of the folder structure or the like is not limited to the DCF. Together with the scene information notified from the input section 3001 and the additional information notified from the additional information generation section 3003, the information processing section 3004 notifies a file name of the image information 2004 when the image information 2004 is recorded on the nonvolatile recording medium 1002 (also acting as address information) to the attribute information generation section 2002 as image shooting information. In this embodiment, the file name is used as the address information, but any information for specifying the position at which the image information 2004 is recorded on the nonvolatile recording medium 1002 and acquiring the image information 2004 is usable. A file path may be used.

(Attribute Information Generation Section 2002)

The attribute information generation section 2002 acquires, from the imaging section 2001, the image shooting information including the scene information, the additional information, and the file name of the image information 2004, provides such an information group with an identifier which allows the information group to be identified uniquely, and records the image shooting information including the identifier on the nonvolatile recording medium 1002 as the attribute information 2005.

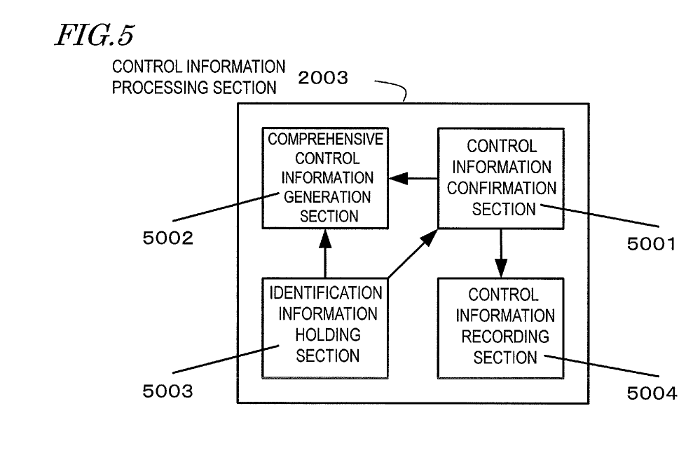

FIG. 4(a) shows an example of an attribute information management table which holds a plurality of pieces of attribute information 2005. The attribute information 2005 is managed in a table format as shown in FIG. 4(a). The attribute information 2005 is managed in rows 4012, 4013 and 4014 of an attribute information management table 4001. In column 4015, an identifier for identifying the information recorded in each row is recorded; and in the other columns, image shooting information notified from the imaging section 2001 is recorded. In this embodiment, in column 4016, the “date information” is recorded. In column 4017, the “scene information” is recorded. In column 4018, the “file name of the image information” is recorded as the address information. Accordingly, in row 4012 of the attribute information management table 4001, information including the identifier “1”, the date information “2008/08/25”, the scene information “landscape”, and the file name of the image information “P1000001.JPG” is recorded. The information to be recorded in the attribute information management table is not limited to such information. The attribute information management table may hold various types of image shooting information notified from the imaging section 2001 including GPS data representing the positional information, memo information input by the user using the input section 3001, and information at the time of image shooting such as the temperature, humidity, acceleration, shutter speed, exposure, focal length or the like acquired by any of various types of sensors mounted on the imaging section 2001.

Here, an example of the attribute information is described. The nonvolatile recording medium 1002 can hold different types of attribute information at the same time. The “different types of attribute information” means attribute information represented indifferent data formats, or attribute information including different types of information. Specifically, attribute information of a different type from that of the attribute information management table 4001 may be, for example, numerical data replacing the information such as the “landscape” or “person” held in column 4017. Instead of the identifier, date information, scene information or file name of the image information, GPS data representing the positional information, acceleration data representing the degree of movement of a hand at the time of image shooting, or the like may be held as the information. The different types of attribute information are not limited to these and may be various other types of information.

As an example, FIG. 4(b) shows an attribute information management table 4002 for managing attribute information of a different type from that of the attribute information management table 4001. In rows 4022, 4023 and 4024 of the attribute information management table 4002, attribute information 2005 is managed. In column 4025, an identifier for identifying the information recorded in each row is recorded. In the other columns, image shooting information notified from the imaging section 2001 is recorded. In column 4026, longitude information of the GPS information is recorded. In column 4027, latitude information of the GPS information is recorded. In column 4028, the “file name of the image information” is recorded. Accordingly, in row 4022 of the attribute information management table 4002, information including the identifier “1”, the GPS longitude information “133.5”, the GPS latitude information “45.3”, and the file name of the image information “P1000001.JPG” is recorded.

Such a state in which different types of attribute information are held at the same time on the nonvolatile recording medium 1002 is assumed to occur when, for example, imaging devices 1001 having different functions or imaging devices 1001 produced by different manufactures are used and the types of attribute information corresponding to the respective imaging devices are written. It is also possible that one imaging device records a plurality of different types of attribute information.

(Control Information Processing Section 2003)

FIG. 5 shows an example of a structure of the control information processing section 2003. As shown in FIG. 5, the control information processing section 2003 includes a control information confirmation section 5001, a comprehensive control information generation section 5002, an identification information holding section 5003, and a control information recording section 5004.

The control information processing section 2003 is assumed to be operated when the power is turned on. The timing at which the control information processing section 2003 is operated is not limited to when the power is turned on, and may be during image shooting, when the power is turned off, when the user performs a specified operation, when the nonvolatile recording medium 1002 is connected to the imaging device 1001, or the like. The control information processing section 2003 does not need to be always operated at any of the above timings, and may be operated only when the control information 2006 has been possibly updated after being operated immediately previous time. It can be determined whether the control information 2006 has been possibly updated as follows. It is found whether the nonvolatile recording medium 1002 has once been detached from the imaging device 1001. When the nonvolatile recording medium 1002 has once been detached and again attached, it is determined that the control information 2006 has been possibly updated. Alternatively, the control information 2006 is provided with the latest update date/time, and it can be determined whether the control information 2006 has been possibly updated by checking the latest update date/time.

When the control information processing section 2003 is operated, the control information confirmation section 5001 is first called to confirm whether the control information 2006 is present on the nonvolatile recording medium 1002. The control information confirmation section 5001 also compares generation identification information recorded in the individual control information 2008 and main body generation identification information held in the identification information holding section 5003. The “generation identification information” is information for identifying each of a plurality of pieces of individual control information 2008. The “main body generation identification information” is information for identifying the imaging device 1001, and includes information corresponding to the generation identification information of the individual control information 2008 to be recorded on the nonvolatile recording medium 1002 by the control information recording section 5004. Such generation identification information and main body generation identification information can be represented in any of various formats such as text strings, numerical values, binary data and the like.

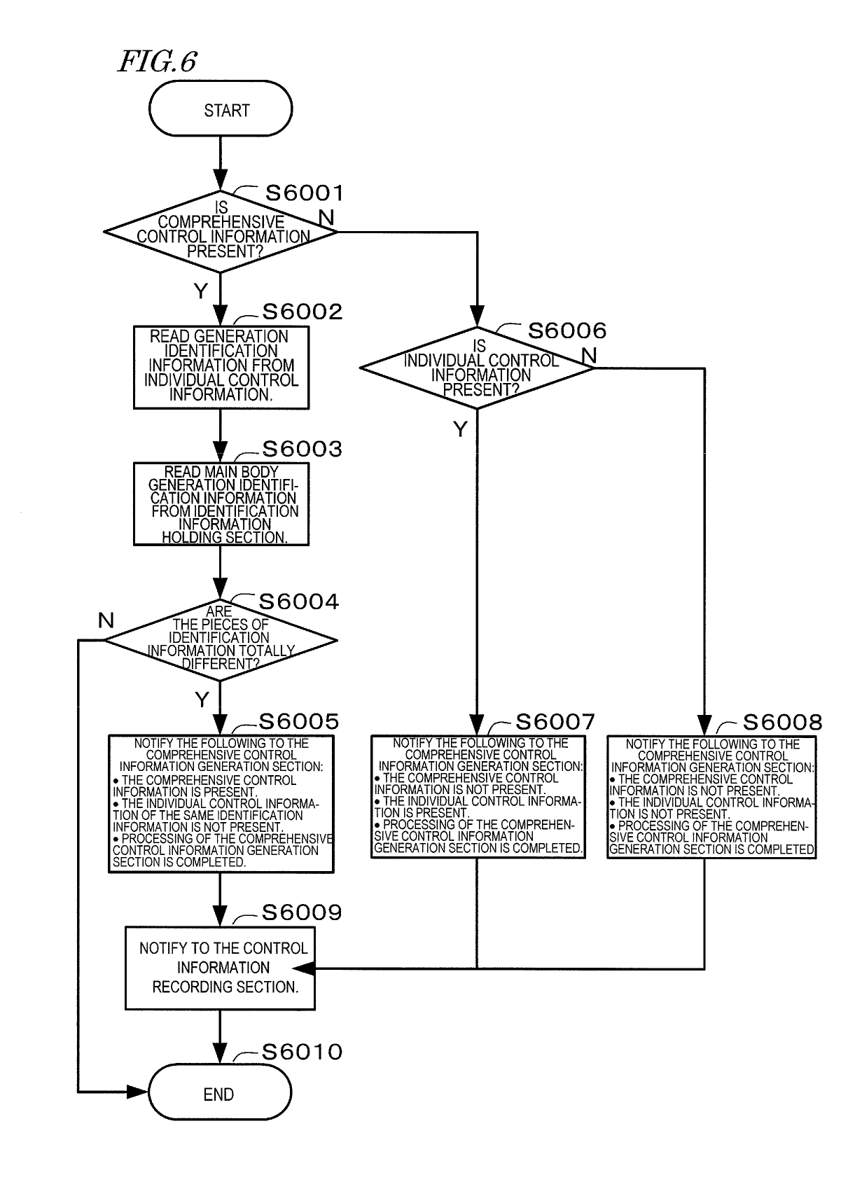

Using a flowchart in FIG. 6, an operation of the control information confirmation section 5001 will be described. First, it is determined whether the comprehensive control information 2007 is present on the nonvolatile recording medium 1002. When it is determined that the comprehensive control information 2007 is present on the nonvolatile recording medium 1002, the operation advances to S6002; whereas when it is determined that the comprehensive control information 2007 is not present on the nonvolatile recording medium 1002, the operation advances to S6006 (S6001).

When it is determined in S6001 that the comprehensive control information 2007 is present, the generation identification information recorded in the individual control information 2008 is read (S6002). When a plurality of pieces of individual control information 2008 are held, the generation identification information is read from all the pieces of individual control information 2008. In this example, the control information 2006 includes one or more pieces of individual control information 2008. Therefore, when the comprehensive control information 2007 is present, the individual control information 2008 is necessarily present.

Next, the main body generation identification information is acquired from the identification information holding section 5003 (S6003). The identification information holding section 5003 will be described later.

One or more pieces of generation identification information read in S6002 is compared with the main body generation identification information acquired in S6003 by a predefined method (S6004). When it is determined that the compared pieces of information are totally different with no matching, the operation advances to S6005. When it is determined that the compared pieces of information include matching information, it can be determined that the individual control information 2008 having the same generation identification information as that of the individual control information held by the control information recording section 5004 has been recorded, and so the operation advances to S6010 and is terminated.

Here, as an example, processing of comparison and determination will be described in the case where in S6002, generation identification information A “Ver-1.0” and generation identification information B “Ver-2.0” are read from two pieces of individual control information 2008, the identification information holding section 5003 holds the main body generation identification information “Camera3-2.0”, and in S6003, the main body generation identification information “Camera3-2.0” is acquired. It is assumed that a method is predefined by which the character string representing the numerals after “-” in the generation identification information is compared with the character string representing the numerals after in “-” the main body generation identification information, and when the strings match each other, it is determined that the compared pieces of information match each other, whereas when the strings do not match each other, it is determined that the compared pieces of information do not match each other. First, the character strings after “-” are taken out from the generation identification information A and the main body generation identification information. The character strings are respectively “1.0” and “2.0”, and do not match each other. Therefore, these pieces of information are determined to be different. Next, the character strings after “-” are taken out from the generation identification information B and the main body generation identification information. The character strings are respectively “2.0” and “2.0”, and match each other. By the above processing, there is one piece of matching information. Therefore, it is determined that the compared pieces of information match each other, and the operation advances to S6010.

Next, it is assumed that in S6002, generation identification information A “Ver-1.0” and generation identification information C “Ver-3.0” are read from two pieces of individual control information 2008, the identification information holding section 5003 holds the main body generation identification information “Camera3-2.0”, and in S6003, the main body generation identification information “Camera3-2.0” is acquired. First, the character strings after “−” are taken out from the generation identification information A and the main body generation identification information. The strings are respectively “1.0” and “2.0”, and do not match each other. Next, the character strings after “-” are taken out from the generation identification information C and the main body generation identification information. The strings are respectively “3.0” and “2.0”, and do not match each other. Thus, all the pieces of generation identification information read in S6002 has been processed and there is no matching information. Therefore, the compared pieces of information are determined to be totally different, and the operation advances to S6005. The formats of the generation identification information and the main body generation identification information, and the method for determining whether the pieces of information match each other are examples, and are not limited to those described above.

When it is determined in S6004 that one or more pieces of generation identification information read in S6002 and the main body generation identification information acquired in S6003 do not have any matching information and are determined to be totally different, the comprehensive control information generation section 5002 is called and processing is performed. The operation of the comprehensive control information generation section 5002 will be described later. After the processing by the comprehensive control information generation section 5002, the operation advances to S6009 (S6005).

When it is determined in S6001 that the comprehensive control information 2007 is not present, it is determined whether the individual control information 2008 is present on the nonvolatile recording medium 1002. When it is determined that the individual control information 2008 is present, the operation advances to S6007; whereas when it is determined that the individual control information 2008 is not present, the operation advances to S6008 (S6006).

When it is determined in S6006 that the individual control information 2008 is present, the comprehensive control information generation section 5002 is called and processing is performed. After the processing by the comprehensive control information generation section 5002, the operation advances to S6009 (S6007). The details of the processing will be described in detail later. The imaging device 1001 in this embodiment performs the processing such that both of the comprehensive control information 2007 and the individual control information 2008 are held on the nonvolatile recording medium 1002 by the operation of the control information processing section 2003. Therefore, when it is determined in S6001 that the comprehensive control information 2007 is not present and it is determined in S6006 that the individual control information 2008 is present, it can be determined that the individual control information 2008 is not recorded by the imaging device 1001 and therefore the generation identification information of the individual control information 2008 is different from the main body generation identification information held by the identification information holding section 5003. However, in the case where, for example, only the comprehensive control information 2007 is deleted by another terminal device or the like, such a determination cannot be made. Separate processing of comparison and determination needs to be performed using the generation identification information of the individual control information 2008 and the main body generation identification information held by the identification information holding section 5003.

When it is determined in S6006 that the individual control information 2008 is not present, the comprehensive control information generation section 5002 is called and processing is performed. After the processing by the comprehensive control information generation section 5002, the operation advances to S6009 (S6008).

When the processing of the comprehensive control information generation section 5002 is completed in S6005, S6007 or S6008, the control information recording section 5004 is called (S6009). The operation of the control information recording section 5004 will be described later.

Thus, the processing of the control information confirmation section 5001 is terminated (S6010).

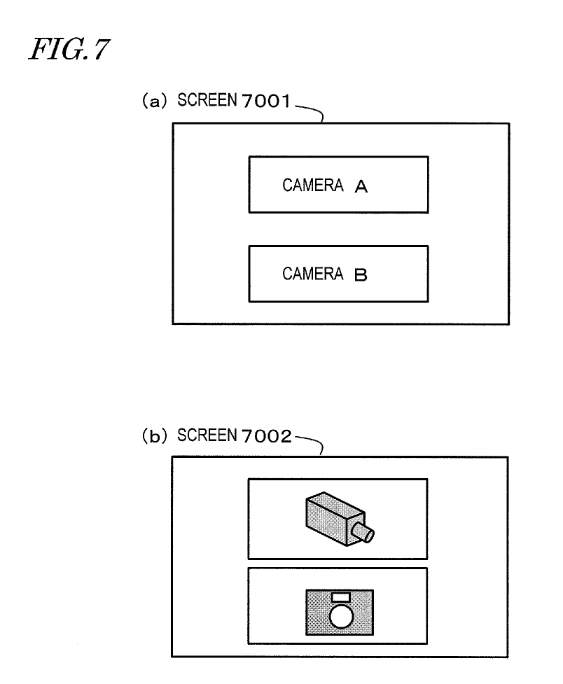

The comprehensive control information generation section 5002, when being called by the control information conformation section 5001, generates or updates the comprehensive control information 2007. First, the comprehensive control information 2007 will be described. The comprehensive control information 2007 presents the user with means for selecting, on the display device 1003, which of one or more pieces of individual control information 2008 is to be processed. FIG. 7(a) show a screen 7001 as an example of display obtained in the case where the comprehensive control information 2007 is processed by the display device 1003. The screen 7001 acts as a user interface. The screen 7001 displays two alternatives of “camera A” and “camera B”. By the user selecting one of the two alternatives using an input device, the individual control information 2008 corresponding to the selected alternative is processed. Here, the alternatives displayed are “camera A” and “camera B” for example, but are not limited to these and may be any information (test strings or image information) usable for specifying the imaging device 1001 which recorded the individual control information 2008 on the nonvolatile recording medium 1002 such as the model name, type number, or manufacturing number of the imaging device 1001, a photograph or image drawing of the imaging device 1001, etc. In the case where one device records a plurality of pieces of individual control information 2008 on the nonvolatile recording medium 1002, any information for specifying each of such pieces of individual control information 2008 may be displayed. For example, as a user interface screen 7002 shown in FIG. 7(b), image drawings of the imaging devices may be used. Hereinafter, such information will be referred to as the “device specifying information”. In this embodiment, one device records one type of individual control information 2008 on the nonvolatile recording medium 1002. In the case where one device records a plurality of pieces of individual control information 2008 on the nonvolatile recording medium 1002, the main body generation identification information corresponds to the individual control information 2008, and the identification information holding section 5003 of the one device has a plurality of pieces of main body generation identification information. In the case where the control information confirmation section 5001 compares the generation identification information of the individual control information 2008 against the main body generation identification information, the individual control information 2008 is compared against all the pieces of main body generation identification information held in the identification information holding section 5003. Based on the device specifying information, the alternatives are generated and displayed. In the case where a plurality of imaging devices 1001 record the individual control information 2008 having the same generation identification information on the nonvolatile recording medium 1002, the alternatives may be displayed such that such a plurality of imaging devices can be specified. The screen 7001 shown in FIG. 7(a) and the screen 7002 shown in FIG. 7(b) both display two alternatives, but the number of alternatives is not limited to two. Alternatives corresponding to one or more pieces of individual control information present on the nonvolatile recording medium 1002 are displayed.

In order to allow the display device 1003 to process the individual control information 2008 as a result of the user performing a selecting operation on the screen 7001, the display device 1003 holds link information to the individual control information 2008 corresponding to each alternative. The “link information” is information which allows the presence of the individual control information 2008 to be specified from the comprehensive control information 2007 and to be processed, in the state where the comprehensive control information 2007 and the individual control information 2008 are held on the nonvolatile recording medium 1002. For example, a file path is usable as the link information. A “file path” is a combination of a site where the individual control information 2008 is recorded and the file name of the individual control information 2008. The link information is not limited to a file path and may be any information for specifying the individual control information 2008 at the time of processing the comprehensive control information 2007, such as a URI (Uniform Resource Identifier), a URL (Uniform Resource Locator), a file name or the like.

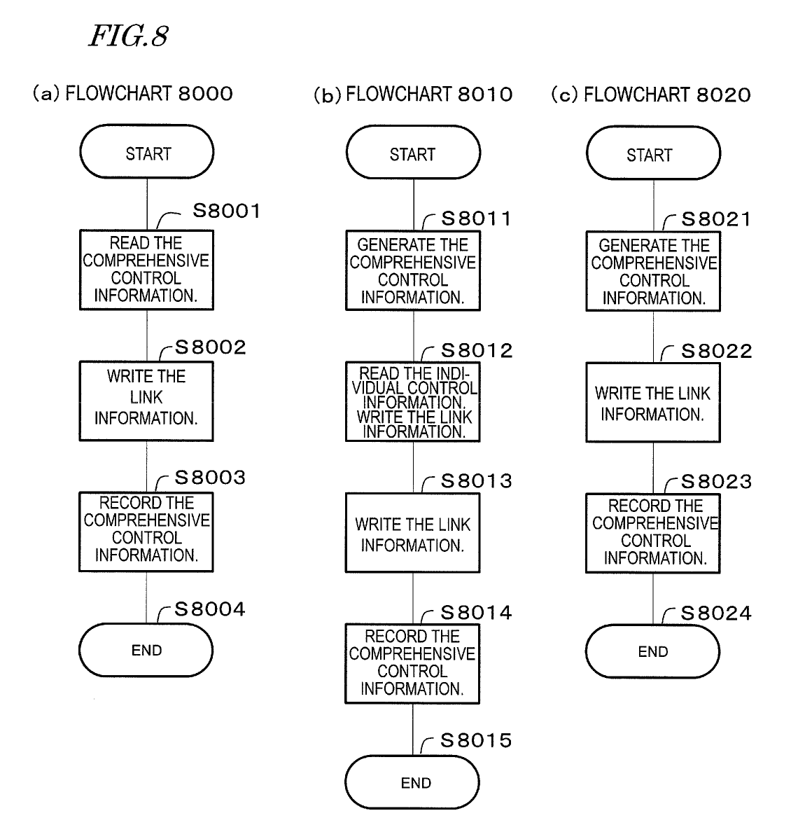

Hereinafter, an example of processing of the comprehensive control information generation section 5002 when the comprehensive control information generation section 5002 is called in S6005 in the processing of the control information confirmation section 5001, is called in S6007 in the processing of the control information confirmation section 5001, and is called in S6008 in the processing of the control information confirmation section 5001 in this order using a flowchart 8000 in FIG. 8(a), a flowchart 8010 in FIG. 8(b), and a flowchart 8020 in FIG. 8(c).

An example of processing of the comprehensive control information generation section 5002 when the comprehensive control information generation section 5002 is called in S6005 in the processing of the control information confirmation section 5001 will be described using the flowchart 8000. When the comprehensive control information generation section 5002 is called in S6005 in the processing of the control information confirmation section 5001, it has been confirmed that the comprehensive control information 2007 is present on the nonvolatile recording medium 1002. Therefore, the comprehensive control information 2007 held on the nonvolatile recording medium 1002 is acquired from the nonvolatile recording medium 1002 (S8001).

In the comprehensive control information 2007 acquired in S8001, link information to the individual control information 2008 held in the control information recording section 5004 is registered (S8002). The individual control information 2008 held in the control information recording section 5004 is information to be recorded on the nonvolatile recording medium 1002 by the processing of the control information recording section 5004. The details of the processing of the control information recording section 5004 will be described later.

The comprehensive control information 2007 already registered on the nonvolatile recording medium 1002 is deleted, and the comprehensive control information 2007 having the link information registered in S8002 is registered on the nonvolatile recording medium 1002 (S8003).

Thus, the processing of the comprehensive control information generation section 5002 is terminated (S8004).

Next, an example of processing of the comprehensive control information generation section 5002 when the comprehensive control information generation section 5002 is called in S6007 in the processing of the control information confirmation section 5001 will be described using the flowchart 8010. When the comprehensive control information generation section 5002 is called in S6007 in the processing of the control information confirmation section 5001, it has been confirmed that the comprehensive control information 2007 is not present, and the individual control information 2008 is present, on the nonvolatile recording medium 1002. Therefore, the comprehensive control information 2007 is newly created (S8011).

One or more pieces of individual control information 2008 recorded on the nonvolatile recording medium 1002 are read, and link information to each piece of individual control information 2008 and the device specifying information are acquired from the read individual control information 2008 and registered in the comprehensive control information 2007 created in S8011 (S8012). As the link information, the file path of the individual control information 2008 is used. As the device specifying information, the model name held in the individual control information 2008 is used. In the case where the individual control information does not include a model name but includes a type number, manufacturing number, photograph or image drawing, one or a plurality thereof are used in accordance with a predefined rule. Alternatively, the generation identification information may be used as the device specifying information.

Next, since it is known in which file path the control information recording section 5004 records the individual control information 2008 on the nonvolatile recording medium 1002, the file path is registered as the link information in the comprehensive control information 2007 created in S8011. The model name is acquired as the device specifying information from the identification information holding section 5003 and registered in the comprehensive control information 2007 created in S8011 (S8013). The device specifying information is not limited to the model name. In the case where the identification information holding section 5003 holds the type number, manufacturing number, photograph, image drawing or the like, one or a plurality thereof may be acquired in accordance with a predefined rule and registered in the comprehensive control information 2007.

The comprehensive control information 2007 thus created is registered on the nonvolatile recording medium 1002 (S8014).

Thus, the processing of the comprehensive control information generation section 5002 is terminated (S8015).

Next, an example of processing of the comprehensive control information generation section 5002 when the comprehensive control information generation section 5002 is called in S6008 in the processing of the control information confirmation section 5001 will be described using the flowchart 8020. When the comprehensive control information generation section 5002 is called in S6008 in the processing of the control information confirmation section 5001, it has been confirmed that neither the comprehensive control information 2007 nor the individual control information 2008 is present on the nonvolatile recording medium 1002. Therefore, the comprehensive control information 2007 is newly created (S8021).

Next, since it is known in which file path the control information recording section 5004 records the individual control information 2008 on the nonvolatile recording medium 1002, the file path is registered as the link information in the comprehensive control information 2007 created in S8021.

The model name is acquired as the device specifying information from the identification information holding section 5003 and registered in the comprehensive control information 2007 created in S8021 (S8022). The device specifying information is not limited to the model name. In the case where the identification information holding section 5003 holds the type number, manufacturing number, photograph, image drawing or the like, one or a plurality thereof may be acquired in accordance with a predefined rule and registered in the comprehensive control information 2007.

The comprehensive control information 2007 thus created is registered on the nonvolatile recording medium 1002 (S8023).

Thus, the processing of the comprehensive control information generation section 5002 is terminated (S8024).

The identification information holding section 5003 holds the main body generation identification information and the device specifying information. In compliance with a request from the control information confirmation section 5001 or the comprehensive control information generation section 5002, the identification information holding section 5003 returns the main body generation identification information or the device specifying information held therein.

As the main body generation identification information, “Camera3-2.0” is held in this example. As the device specifying information, the model name “camera A” is used in this example. The device specifying information is not limited to the model name, and may be one or a plurality of the type number, manufacturing number, photograph, image drawing, text strings input by the user in advance and the like are usable in accordance with a predefined rule because any information allowing the user to specify the device group is usable.

Upon receipt of the notification from the control information confirmation section 5001, the control information recording section 5004 records, on the nonvolatile recording medium 1002, the individual control information 2008 usable for generating a screen by the display device 1003 using the image information 2004 and the attribute information 2005 recorded on the nonvolatile recording medium 1002. The individual control information 2008 is held in advance in the control information recording section 5004, and is recorded on the nonvolatile recording medium 1002 when being called by the control information confirmation section 5001. The individual control information 2008 to be recorded includes the generation identification information. The individual control information 2008 to be recorded on the nonvolatile recording medium 1002 at this point corresponds to the type of the attribute information 2005 recorded on the nonvolatile recording medium 1002 by the attribute information generation section 2002. In this example, the attribute information generation section 2002 of the imaging device 1001 is preconditioned to record one type of attribute information 2005 on the nonvolatile recording medium 1002. However, the attribute information generation section 2002 is not limited to this and may record two or more types of attribute information 2005 on the nonvolatile recording medium 1002. In this case, the control information recording section 2004 records, on the nonvolatile recording medium 1002, two or more pieces of individual control information 2008 corresponding to the types of attribute information 2005 recorded by the attribute information generation section 2002 on the nonvolatile recording medium 1002.

The correspondence between the individual control information 2008 and the attribute information 2005 is specified by causing the individual control information 2008 to hold information specifying the corresponding attribute information 2005. As the information specifying the information 2005, a file path of the attribute information 2005 on the nonvolatile recording medium 1002 is used. The method for specifying the correspondence is not limited to the above method of causing the individual control information 2008 to hold the information specifying the corresponding attribute information 2005, and may be any method which allows the correspondence between the individual control information 2008 and the attribute information 2005 to be specified. For example, the individual control information 2008 and the corresponding attribute information 2005 may be located in the same directory in the nonvolatile recording medium 1002.

The correspondence between the individual control information 2008 and the attribute information 2005 is not limited to a one-to-one correspondence. In the case where the individual control information 2008 can interpret and process a plurality of types of attribute information 2005, the individual control information 2008 and the attribute information 2005 may have a one-to-plural correspondence. It is also conceivable that a plurality of pieces of individual control information 2008 correspond to one piece of attribute information 2005.

A plurality of pieces of individual control information 2008 may be held in the control information recording section 5004 in advance, and one thereof may be automatically selected based on the input or settings provided by the user, the date/time information or the like before being recorded on the nonvolatile recording medium 1002, and then recorded thereon. Instead of the individual control information 2008 being held in the control information recording section 5004 in advance, the control information recording section 5004 may generate the individual control information 2008 before recording the individual control information 2008 on the nonvolatile recording medium 1002, and then record the individual control information 2008 on the nonvolatile recording medium 1002. The individual control information 2008 is described using a programming language which can be processed by the display device 1003, such as JavaSpript (registered trademark) or the like. The individual control information 2008 is not limited to information described using a programming language such as JavaSpript (registered trademark) or the like, and may be any information for controlling, for example, a procedure of processing, or a method of displaying, the attribute information 2005 and/or the image information 2004 by the display device 1003.

(Display Device 1003)

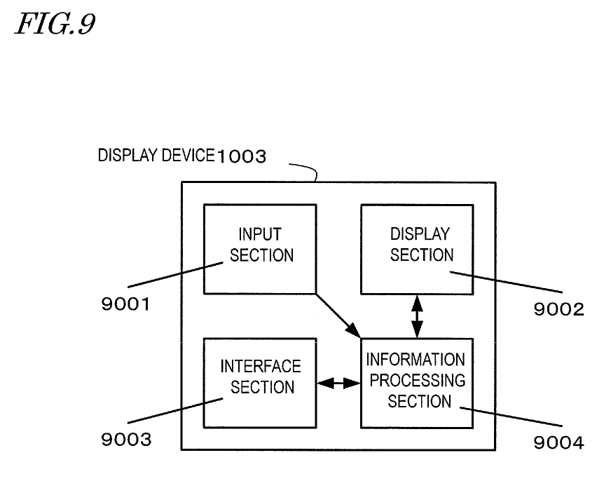

As shown in FIG. 9, the display device 1003 includes an input section 9001, a display section 9002, an interface section 9003, and an information processing section 9004. The input section 9001 receives an input from the user. Specifically, the input section 9001 may be a keyboard, a touch panel, an infrared remote control or the like. The display section 9002 displays the processing results of the information processing section 9004. Specifically, the display section 9002 may be formed of a display module such as a liquid crystal module, a plasma display module or the like. The interface section 9003 is connected to the nonvolatile recording medium 1002, reads information recorded on the nonvolatile recording medium 1002, and notifies the information to the information processing section 9004. The interface section 9003 also records the information from the information processing section 9004 on the nonvolatile recording medium 1002. The information processing section 9004 generates screen information to be displayed based on the information notified from the interface section 9003 and the information from the input section 9001, and displays the screen information on the display section 9002.

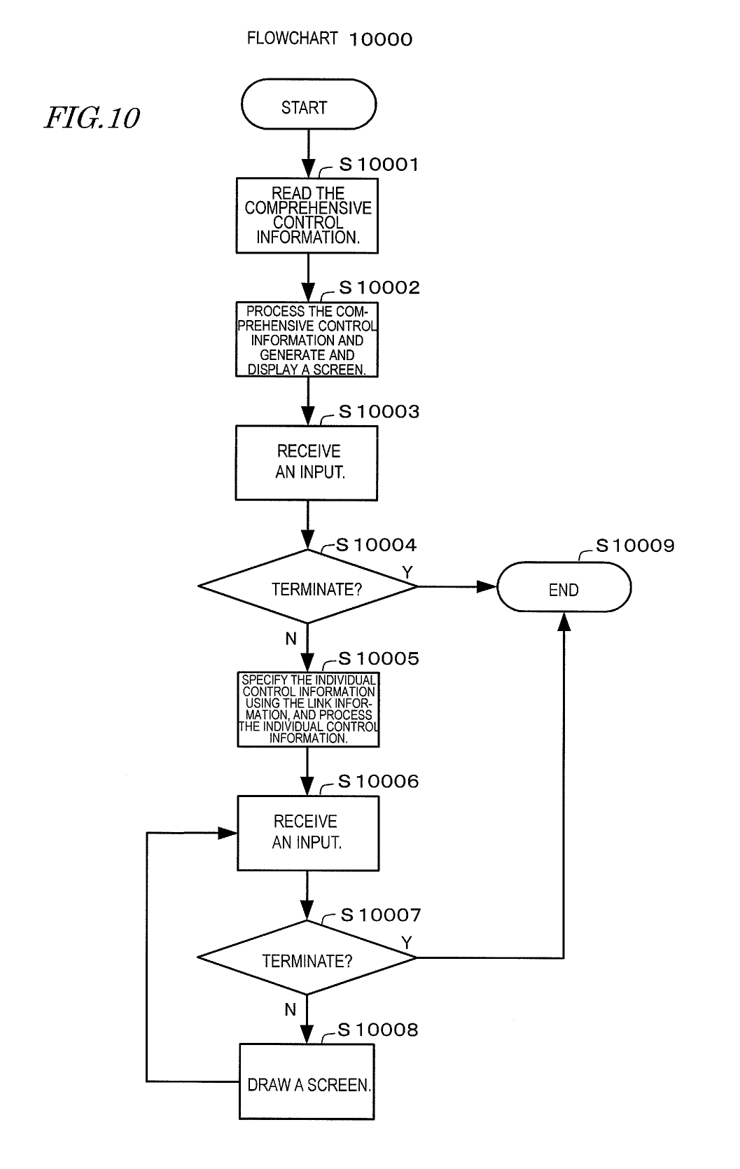

Using a flowchart 10000 shown in FIG. 10, an example of processing by the display device 1003 will be described. The nonvolatile recording medium 1002 is connected to the interface section 9003, and the comprehensive control information 2007 recorded on the nonvolatile recording medium 1002 is read (S10001).

The comprehensive control information 2007 read in S10001 is processed, the individual control information 2008 is selected using the device specifying information held in the comprehensive control information 2007, a screen including the alternatives for selection and determination is generated, and the screen is displayed on the display section 1002 (S10002).

The input section 9001 receives an operation by the user as an input (S10003).

When the input received in S10003 indicates termination of the processing, the operation advances to S10009; whereas when the input received in S10003 does not indicate termination of the processing but indicates that selection and determination of an alternative has been performed, the operation advances to S10005 (S10004).

When the input received in S10003 indicates that selection and determination of an alternative has been performed, the individual control information 2008 is read from the nonvolatile recording medium 1002 based on the link information corresponding to the selection results and held by the comprehensive control information 2007, and is processed. During the processing, the attribute information 2005 corresponding to the individual control information 2008 is read from the nonvolatile recording medium 1002. A screen is generated by processing the individual control information 2008 and the attribute information 2005 corresponding to each other, and displayed on the display section 9002 (S10005).

The input section 9001 receives an operation by the user as an input (S10006).

When the input received in S10006 indicates termination of the processing, the operation advances to S10009; whereas when the input received in S10006 does not indicate termination of the processing but indicates an operation made on the screen displayed by processing of the individual control information, the operation advances to S10008 (S10007).

When the input received in S10006 indicates an operation made on the screen displayed by processing of the individual control information 2008, the processing corresponding to the operation is performed, and a screen is generated when necessary and displayed on the display section 9002 (S10008).

When the input received in S10003 and S10006 indicates termination of the processing, the processing is terminated (S10009).

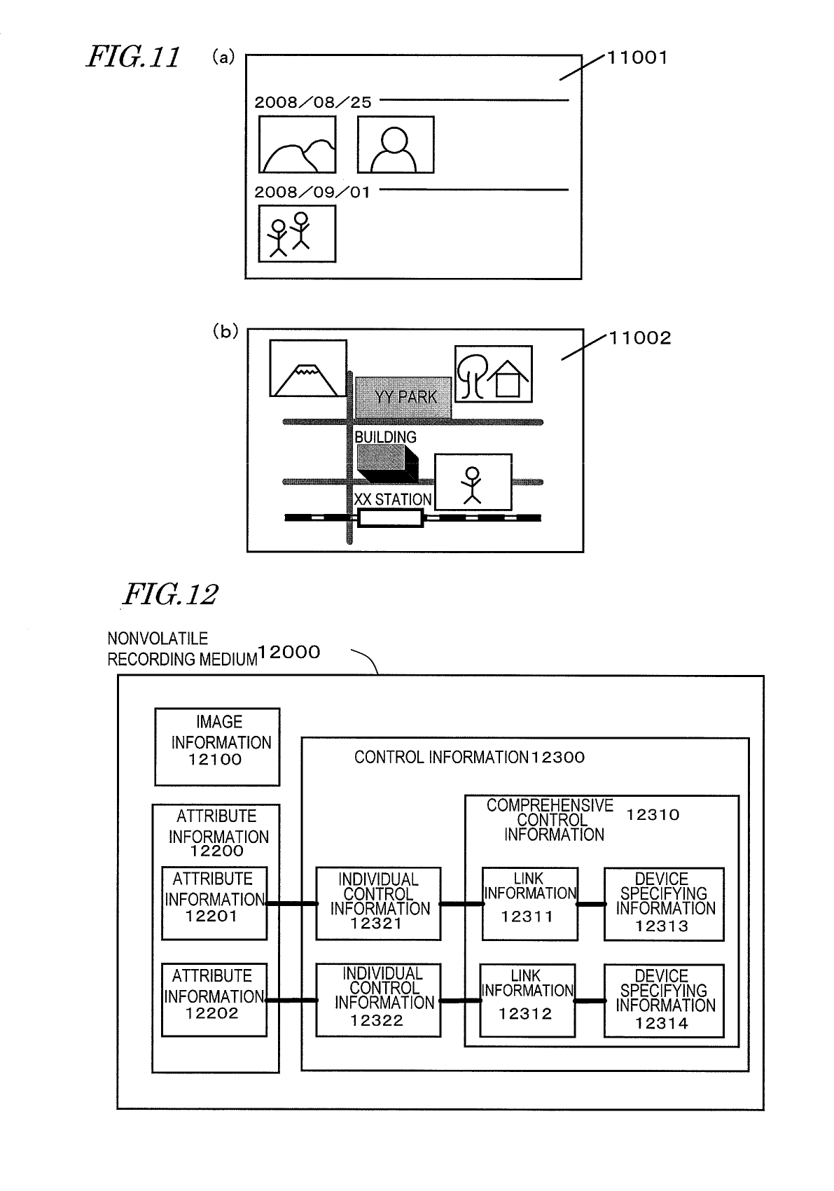

Hereinafter, using a specific example, an operation of the display device 1003 will be described. As a result of the operation of the imaging device 1001, as shown in FIG. 12, a nonvolatile recording medium 12000 has image information 12100 formed of a plurality of shot images, two types of attribute information 12201 and 12202 as attribute information 12200, and one piece of comprehensive control information 12310 and two pieces of individual control information 12321 and 12322 corresponding to the two types of attribute information 12201 and 12202 as control information 12300. An example of an operation of the display device 1003 in such a case will be described using the screen 7001 shown in FIG. 7(a) and screens 11001 and 11002 respectively shown in FIG. 11(a) and FIG. 11(b).

The comprehensive control information 12310 holds link information to the individual control information 12321 and the individual control information 12322 respectively as link information 12311 and link information 12312. The comprehensive control information 12310 also holds device specifying information 12313 and device specifying information 12314 respectively as device specifying information corresponding to the individual control information 12321 and device specifying information corresponding to the individual control information 12322. Here, it is assumed that the device specifying information 12313 is text information of “camera A”, and the device specifying information 12314 is text information of “camera B”.

The description will be given in accordance with the flowchart 10000. First, in S10001, the nonvolatile recording medium 12000 is connected to the interface section 9003, and the comprehensive control information 12310 recorded on the nonvolatile recording medium 12000 is read.

In S10002, the comprehensive control information 12310 read in S10001 is processed. Using the device specifying information 12313 and the device specifying information 12314 held in the comprehensive control information 12310, a screen including alternatives for selecting the individual control information 12321 and the individual control information 12322 is generated and displayed on the display section 9002. An example of the displayed screen is shown as the screen 7001 in FIG. 7(a). The screen 7001 displays alternatives created using the device specifying information 12313 and the device specifying information 12314, and is in a state which allows the user to make an input from the input section 9001 and to select and determine an alternative. Here, it is assumed that the user selects and makes a determination on “camera A” of the alternatives.

In S10003, information input by the user using the input section 9001 on the screen displayed in S10002 is acquired. Here, the information indicating that selection and determination of “camera A” has been performed is acquired.

Because the information from the input section 9001 acquired in S10003 indicates that selection and determination of “camera A” has been performed, such information does not indicate termination of the processing but indicates that selection and determination of an alternative has been performed. Accordingly, in S10004, the operation advances to S10005.

In S10003, the information indicating that selection and determination of “camera A” has been performed is received. Therefore, based on the link information 12311 to the individual control information 12321 corresponding to “camera A”, which is the device specifying information 12313 held in the comprehensive control information 12310, the individual control information 12321 is read from the nonvolatile recording medium 12000 and processed. During this processing, the attribute information 12201 corresponding to the individual control information 12321 is read from the nonvolatile recording medium 12000. An example of the attribute information 12201 may be the attribute information recorded in the attribute information management table 4001 shown in FIG. 4(a). By processing the individual control information 12321, a screen is generated and displayed on the display section 9002. An example of the screen displayed at this point is the screen 11001 shown in FIG. 11(a). Using the date information held in the attribute information 12201, the screen 11001 displays a part of a plurality of pieces of image information 12100 as classified in accordance with the date.

When the input from the user received in S10006 indicates termination of the processing, the operation advances to S10009 and the processing is terminated. When the input from the user received in S10006 indicates an operation made on the screen 11001, processing corresponding to the operation is performed, and a screen is generated when necessary and displayed on the display section 9002 in S10008. The operation made on the screen 11001 may be any of various operations such as selecting the displayed image information, moving the page, and the like.

Next, an example of processing will be described in the case where in S10003, “camera A” is not selected by the user using the input section 9001 unlike in the above-described case but selection and determination of “camera B” is performed on the screen displayed in S10002.

Because the information from the input section 9001 acquired in S10003 indicates that selection and determination of “camera B” has been performed, such information does not indicate termination of the processing but indicates that selection and determination of an alternative has been performed. Accordingly, in S10004, the operation advances to S10005.

In S10003, the information indicating that selection and determination of “camera B” has been performed is received. Therefore, based on the link information 12312 to the individual control information 12322 corresponding to “camera B”, which is the device specifying information 12314 held in the comprehensive control information 12310, the individual control information 12322 is read from the nonvolatile recording medium 12000 and processed. During this processing, the attribute information 12202 corresponding to the individual control information 12322 is read from the nonvolatile recording medium 12000. An example of the attribute information 12202 may be the attribute information recorded in the attribute information management table 4002 shown in FIG. 4(b). By processing the individual control information 12322, a screen is generated and displayed on the display section 9002. An example of the screen displayed at this point is the screen 11002 shown in FIG. 11(b). Using the positional information held in the attribute information 12202, the screen 11002 displays a part of a plurality of pieces of image information 12100 at corresponding positions on a map.

When the input from the user received in S10006 indicates termination of the processing, the operation advances to S10009 and the processing is terminated. When the input from the user received in S10006 indicates an operation made on the screen 11002, processing corresponding to the operation is performed, and a screen is generated when necessary and displayed on the display section 9002 in S10008. The operation made on the screen 11002 may be any of various operations such as selecting the displayed image information, moving the page, and the like.

By using the imaging device described above, comprehensive control information and the individual control information are recorded on the nonvolatile recording medium as attribute information and as control information including the procedure for performing display by the display device using the attribute information and the image information, in addition to conventional image information.

By using the individual control information corresponding to the types of the attribute information, attribute information corresponding to the type, generation, manufacturer or the like of the imaging device can be recorded, and also the display device can present the user with a screen corresponding to the type, generation, manufacturer or the like of the imaging device.

By recording a plurality of pieces of individual control information for one piece of attribute information, the display device can present a screen corresponding to the situation or the selection by the user.

By recording the comprehensive control information including the individual control information corresponding the attribute information and the link information to the individual control information, the display device can present the user with a screen including alternatives using the comprehensive control information, and specify and process the individual control information using the link information held in the comprehensive control information. Thus, all the pieces of image information managed by attribute information described in a plurality of different formats can be viewed.

By causing the comprehensive control information to hold the device specifying information, the user is allowed to easily specify and select the imaging device or a group of the imaging devices used for image shooting.

By confirming the comprehensive control information or the individual control information already recorded and recording comprehensive control information and individual control information based on the results, overlapped recording of the comprehensive control information and the individual control information can be prevented.

In the case where the comprehensive control information is not recorded on the nonvolatile recording medium, the individual control information is recorded on the nonvolatile recording medium, and the generation identification information of the recorded individual control information does not match the main body generation identification information held by the imaging device, the link information to the individual control information recorded on the nonvolatile recording medium and the link information to the individual control information to be recorded by the imaging device are both recorded in the comprehensive control information, and the comprehensive control information is recorded on the nonvolatile recording medium. Owing to this, even the individual control information recorded on the nonvolatile recording medium by the imaging device which does not have a function of recording the comprehensive control information on the nonvolatile recording medium can be referred to from the comprehensive control information. Thus, even the image information recorded by the imaging device which does not have a function of recording the comprehensive control information on the nonvolatile recording medium can be viewed from a menu screen obtained by processing the comprehensive control information by an operation performed on the screen.

In the case where the comprehensive control information has already been recorded on the nonvolatile recording medium, the comprehensive control information is read and combined with link information to the individual control information to be recorded to create new comprehensive control information, and the new comprehensive control information is recorded instead of the comprehensive control information already recorded on the nonvolatile recording medium. Owing to this, generation of a plurality of pieces of comprehensive control information is avoided, and all the pieces of image information can be viewed from one menu screen obtained by processing one piece of comprehensive control information by an operation performed on the screen.

By using a recording medium to which the present invention is applied, even in the case where different pieces of attribute information are recorded in different formats by different devices, the control information corresponding to each piece of attribute information is recorded and so the correspondence therebetween can be specified. Therefore, by processing the control information by the display device, the image information can be viewed using the attribute information.

On a recording medium to which the present invention is applied, the individual control information corresponding to the attribute information and the comprehensive control information having the link information to the individual control information are recorded. Therefore, by starting the processing from the comprehensive control information by the display device, all the pieces of image information managed by attribute information written in a plurality of different formats can be viewed from one menu screen.

The nonvolatile recording medium 1002 is not limited to a detachable recording medium, and may be any recording medium which can be commonly used by a plurality of types of terminal devices 1001 and can be read by the display device 1003. For example, the nonvolatile recording medium 1002 may be an installation type recording medium which collectively stores various data in a home network. On such an installation type recording medium, a plurality of types of terminal devices 1001 record attribute information 2005 in different formats. Even in such a case, by generating and recording the comprehensive control information 2006 corresponding to these plurality of types of attribute information 2005 on the side of the terminal devices 1001, the image information 2004 can be viewed by the display device 1003 using the attribute information 2005.

As described above, the terminal device 1001 according to the present invention may be a health measurement device. In the case where the terminal device 1001 is, for example, a weighing device, living body information indicating the measured body weight, body fat ratio, body composition or the like is recorded on the nonvolatile recording medium 1002 as the user data 2004 displayable by the display device 1003.

Table 1 compares the imaging device and the weighing device regarding the user data, attribute information, and individual control information.

TABLE 1

| | Imaging device | Weighing device |
|---|---|---|
| User data | Image information | Body weight data |
| Attribute information | Shooting date/time | Measuring |
| | | date/time |
| Individual control | List representation | Graphic |
| information | | representation |

For easier understanding, Table 1 shows representative examples of the information. The user data 2004 is the image information 2004 in the above embodiment of the imaging device 1001, but is living body information 2004 in the case of the weighing device 1001. Table 1 shows body weight data as an example of the living body information 2004. The imaging device 1001 generates the attribute information 2005 based on the information from the imaging section 2001. In the case of the weighing device 1001, a sensor section for detecting the body weight of the user and generating body weight data corresponds to the imaging section 2001, and the body weight data corresponds to the image information 2004.

The weighing device 1001 includes an attribute information generation section 2002, and generates attribute information 2005 based on the information such as the body weight data 2004 output by the sensor section 2001, the measuring date/time of the body weight, the user name as a target of the measurement or the like. The attribute information 2005 is information for managing the correspondence among the body weight data, the measuring date/time, the user name and the like. In the above embodiment of the imaging device 1001, the image information 2004 and the attribute information 2005 are held as different files. In another example, the attribute information 2005 may be recorded in a header of the image file, and the image information 2004 and the attribute information 2005 may be held as one file. The weighing device 1001 may also generate a file of a similar format, or the body weight data 2004 and the attribute information 2005 may be managed in the form of a table.

The weighing device 1001 includes a control information processing section 2003, generates individual control information 2008 corresponding to the attribute information 2005, and records the individual control information 2008 on the nonvolatile recording medium 1002. The individual control information 2008 generated by the imaging device 2001 is, for example, information for displaying images in the form of a list; whereas in the weighing device 1001, the individual control information 2008 is information for displaying, for example, the body weight data in a graph.

The display device 1003 can display the body weight data 2004 read from the nonvolatile recording medium 1002 in accordance with the individual control information 2008. The user can manage his/her health by checking the graph of the body weight displayed by the display device 1003. In the case where user data (image data, blood pressure value, number of steps, etc.) generated by a different terminal device from the weighing device 1001 (imaging device, tonometer, pedometer, etc.) is already recorded on the nonvolatile recording medium 1002, the weighing device 1001 generates comprehensive control information 2007 and records the comprehensive control information 2007 on the nonvolatile recording medium 1002. Owing to this, the display device 1003 can display a user interface which allows the user data 2004 of the weighing device 1001 and the different terminal device to be viewed.

The present invention relates to an imaging device, an imaging method and a program of the imaging method, and is applicable to a digital still camera, a digital video camera, and also a device having a function of imaging a moving picture or a still picture such as a mobile phone having a function of the digital still camera or the digital video camera. The present invention is also applicable to a health measurement device for measuring living body information, such as a weighing device, a tonometer, a pedometer, an activity meter, or the like.

The present application claims the benefit of priority based upon a Japanese Patent Application filed on Nov. 25, 2009 (Japanese Patent Application No. 2009-267112). The contents of the Japanese Patent Application is incorporated herein by reference.

What is claimed is:

1. A terminal device, comprising:
a user data generation section for generating user data;
an attribute information generation section for generating attribute information which represents attribute of the generated user data; and
control information processing section for recording, on a nonvolatile recording medium, control information which corresponds to the attribute information and represents a procedure of displaying the user data on a display device;
wherein the control information includes:
individual control information representing a procedure of displaying the user data; and
comprehensive control information including link information to the individual control information.

2. The terminal device of claim 1, wherein in the case where different user data generated by a device different from the terminal device and different individual control information representing a procedure of displaying the different user data are already recorded on the nonvolatile recording medium, the comprehensive control information further includes link information to the different individual control information.

3. The terminal device of claim 2, wherein the comprehensive control information provides the display device with a user interface which allows a user to select which of the user data generated by the terminal device and the different user data generated by the different device is to be displayed.

4. The terminal device of claim 3, wherein the comprehensive control information includes device specifying information for specifying each of the terminal device and the different device.

5. The terminal device of claim 4, wherein the device specifying information is a test string capable of specifying a model of each of the terminal device and the different device.

6. The terminal device of claim 4, wherein the device specifying information is image information capable of specifying a model of each of the terminal device and the different device.

7. The terminal device of claim 1, wherein the control information processing section checks whether or not control information is already recorded on the nonvolatile recording medium, and determines a type of control information to be recorded on the nonvolatile recording medium in accordance with a result of the checking.

8. The terminal device of claim 7, wherein in the case where as a result of the checking, neither individual control information nor comprehensive control information is recorded on the nonvolatile recording medium, the control information processing section generates the comprehensive control information including the link information to the individual control information generated by the terminal device, and records the generated individual control information and the generated comprehensive control information on the nonvolatile recording medium.

9. The terminal device of claim 7, wherein in the case where as a result of the checking, individual control information is already recorded on the nonvolatile recording medium but comprehensive control information is not recorded, and identification information of the individual control information generated by the terminal device does not match identification information of the already recorded individual control information, the control information processing section generates comprehensive control information including the link information to the generated individual control information and link information to the already recorded individual control information, and records the generated individual control information and the generated comprehensive control information on the nonvolatile recording medium.

10. The terminal device of claim 7, wherein in the case where as a result of the checking, comprehensive control information and individual control information are already recorded on the nonvolatile recording medium, and identification information of the individual control information generated by the terminal device matches identification information of the already recorded individual control information, the control information processing section does not record the generated individual control information on the nonvolatile recording medium.

11. The terminal device of claim 7, wherein in the case where as a result of the checking, comprehensive control information and individual control information are already recorded on the nonvolatile recording medium, and identification information of the individual control information generated by the terminal device does not match identification information of the already recorded individual control information, the control information processing section reads the comprehensive control information already recorded on the nonvolatile recording medium, generates new comprehensive control information including the link information to the generated individual control information and link information included in the already recorded comprehensive control information, records the generated individual control information on the nonvolatile recording medium and also rewrites the comprehensive control information already recorded on the nonvolatile recording medium with the new comprehensive control information.

12. The terminal device of claim 1, wherein the control information processing section causes the control information to correspond to the attribute information by recording the control information and the attribute information in the same directory in the nonvolatile recording medium.

13. The terminal device of claim 1, wherein the control information processing section causes the control information to correspond to the attribute information by causing a file path representing the position of the attribute information in the nonvolatile recording medium to be included in the control information.

14. The terminal device of claim 1, wherein:
the terminal device is an imaging device; and
the user data is image shooting data.

15. The terminal device of claim 1, wherein:
the terminal device is a health measurement device; and
the user data is living body information.

16. A nonvolatile recording medium, comprising:
user data;
attribute information representing attribute of the user data; and
control information corresponding to the attribute information and representing a procedure of displaying the user data by a display device.

17. The nonvolatile recording medium of claim 16, wherein the control information includes:
individual control information representing a procedure of displaying the user data; and
comprehensive control information including link information to the individual control information.

18. The nonvolatile recording medium of claim 17, wherein:
the user data and the control information are information generated and recorded on the nonvolatile recording medium by a terminal device;
different user data generated by device different from the terminal device and different individual control information representing a procedure of displaying the different user data are recorded on the nonvolatile recording medium; and
the comprehensive control information further includes link information to the different individual control information.

19. The nonvolatile recording medium of claim 18, wherein the comprehensive control information provides the display device with a user interface which allows a user to select which of the user data generated by the terminal device and the different user data generated by the different device is to be displayed.

20. The nonvolatile recording medium of claim 16, wherein the control information includes a file path representing the position of the attribute information in the nonvolatile recording medium in order to show the correspondence between the control information and the attribute information.

21. The nonvolatile recording medium of claim 18, wherein the comprehensive control information includes device specifying information for specifying each of the terminal device and the different device.

22. The nonvolatile recording medium of claim 18, wherein:
the terminal device is an imaging device; and
the user data is image shooting data.

23. The nonvolatile recording medium of claim 18, wherein:
the terminal device is a health measurement device; and
the user data is living body information.
